(19) United States
(12) Patent Application Publication
(10) Pub. No.: US 2026/0163787 A1
(43) Pub. Date: Jun. 11, 2026

(54) DISASTER RECOVERY SOLUTION FOR CLOUD-BASED COMPUTING ENVIRONMENT

(71) Applicant: Palo Alto Networks, Inc., Santa Clara, CA (US)

(72) Inventors: Amit Kumar Ray, Milpitas, CA (US); Mihir Lala, Cupertino, CA (US); Mangam Prabhakar Mangam Vijaya Bhaskara Rao, San Jose, CA (US); Veera Satya Teja Suman Mutyala, Tracy, CA (US)

(21) Appl. No.: 18/976,494

(22) Filed: Dec. 11, 2024

(51) Int. Cl. H04L 41/0659; H04L 61/4511; H04L 67/10

(52) U.S. Cl. CPC H04L 41/0659; H04L 61/4511; H04L 67/10

(57) ABSTRACT

In response to a disaster recovery trigger, a disaster recovery controller blocks all traffic to the gateway associated with the active deployment by updating the traffic routing policy of a DNS server. The disaster recovery controller instructs nodes of storage resources in the active deployment to synchronize with storage resources in the standby deployment. After synchronization is completed, the disaster recovery controller updates the DNS traffic routing policy to allow traffic to be sent to the gateway of the standby deployment. Clients of a collection of cloud supported services use a network administration tool to periodically query for a DNS record associated with current regional endpoint of the active gateway, updating their locally cached endpoint identifier with the identifier of the record.

### BACKGROUND

The disclosure generally relates to disaster recovery in cloud-based computing (e.g., subclass CPC G06F 11/1464).

A disaster recovery (DR) plan, sometimes including or combined with business continuity, is a business plan for recovering from a disaster. In the context of cloud computing, a DR plan is a plan for recovering data, workloads, and/or compute resources after a disaster (e.g., major power outage, natural disaster, severe hardware failure, regional conflict, etc.) disrupts cloud infrastructure in a region. A cloud DR plan will be constructed to satisfy metrics including a recovery time objective (RTO) and a recovery point objective (RPO) which may be specified in a service level agreement (SLA). The architecture employed to satisfy the metrics in a service level objective (SLO) in an SLA for a cloud computing model is multi-region deployment of the service (e.g., application, platform, etc.) being supported by cloud infrastructure. Cloud DR solutions with a multi-region deployment architecture can generally be categorized as active/passive, active/standby, and active/active, each of which is sometimes referred to as a failover strategy. Each of the failover strategies involves deploying a cloud supported service (e.g., Platform-as-a-Service (PaaS), Software-as-a-Service (Saas), or Infrastructure-as-a-Service (IaaS)) in different, physical regions. In an active/passive strategy, the passive deployment is idle or shutdown. In an active/active strategy, client transactions are distributed between both deployments with each deployment being capable of handling the load if the other deployment fails due to a disaster that impacts its supporting cloud infrastructure. In the active/standby strategy, the active deployment serves clients while the state of the standby deployment is synchronized with the active deployment.

### BRIEF DESCRIPTION OF THE DRAWINGS

Embodiments of the disclosure may be better understood by referencing the accompanying drawings.

FIG. 1 is a diagram of an example method for transferring traffic to a standby deployment of cloud infrastructure upon detection of a disaster response trigger in an active deployment of cloud infrastructure.

FIG. 2 is a flowchart of example operations for failing over from an active (i.e., “first”) deployment of a cloud-based service to a standby (i.e., “second”) deployment of a cloud-based service.

FIG. 3 is a flowchart of example operations for monitoring DNS information for changes in endpoint identifier of a cloud-based service domain to detect failover of the cloud-based service to a different region.

FIG. 4 is a flowchart of example operations for migrating tenants of a cloud-based service to efficient disaster recovery that uses multi-region keys.

FIG. 5 depicts an example computer system with a disaster recovery controller and a client of a cloud-based service which monitors regional failover.

### DESCRIPTION

The description that follows includes example systems, methods, techniques, and program flows to aid in understanding the disclosure and not to limit claim scope.

Well-known instruction instances, protocols, structures, and techniques have not been shown in detail for conciseness.

### Terminology

The description uses the term “deployment” to refer to a collection of services that have been deployed onto cloud-based infrastructure in a specific geographic region to include the data, and the code to run those services. The term also encapsulates any configuration of the underlying cloud-based infrastructure which is associated with the deployed services.

The term “standby” in relation to a deployment (e.g., a standby deployment) refers to a deployment which is use-ready and has actively running services even when the deployment is in standby. This term is used to differentiate from a “passive” or “cold” deployment which refers to a deployment where infrastructure is not use-ready and requires longer periods of time to be brought online and transferred over to when used in a disaster recovery failover. The term also is used to differentiate from a “hot” or “active” deployment, which is also use-ready but does not require any additional actions by a system or user to become useable.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider. In more general terms, a cloud service provider resource accessible to customers is a resource owned/managed by the cloud service provider entity that is accessible via network connections. Often, the access is in accordance with an application programming interface (API), or software development kit provided by the cloud service provider.

The description also uses the term “regional endpoint” in a cloud computing context to refer to a request endpoint for a specified region. A service provider (e.g., a cloud service provider or a provider of an application that uses resources of a cloud service provider) that offers a service in multiple regions will specify a domain name for a regional endpoint based on a region identifier. For example, a provider offers a service or web-based application identified with service domain security.service.corp1.com. The provider offers the service in two different regions identified as ASIA-NORTH and ASIA-CENTRAL. The provider defines a uniform resource locator (URL)with a request template for its service as https://security.<region>.malwarescan.corp1.com/tenant_id.

The identifiers of the regional endpoints to receive requests will be https://security.asia-north.malwarescan.corp1.com/tenant_id and https://security.asia-central.malwarescan.corp1.com/tenant_id.

### Overview

A disaster recovery (DR) solution for cloud-based services has been created that can fail over a cloud-based service and tenants of the cloud-based service efficiently, reducing failover in an active/standby strategy from hours to minutes. This DR solution orchestrates synchronization of assets between an active deployment of a cloud-based service in a first region to a standby deployment of the cloud-based service in a different region. A disaster recovery controller updates a traffic routing policy to block traffic to an application programming interface (API) gateway of the cloud-based service in the active deployment. The disaster recovery controller then instructs a node that manages a set of storage resources in the active region to synchronize with storage resources in the standby region. After synchronization is completed, the disaster recovery controller updates the traffic routing policy to allow traffic to be sent to the API gateway of the standby deployment. Clients of the cloud-based service use a network administration tool to periodically query for a DNS record associated with a current regional endpoint of the active API gateway. The clients compare a locally cached endpoint identifier with the endpoint identifier to determine if a failover has occurred. If the endpoint identifiers do not match, the clients update the locally cached endpoint identifier with the DNS record identifier.

### Example Illustrations

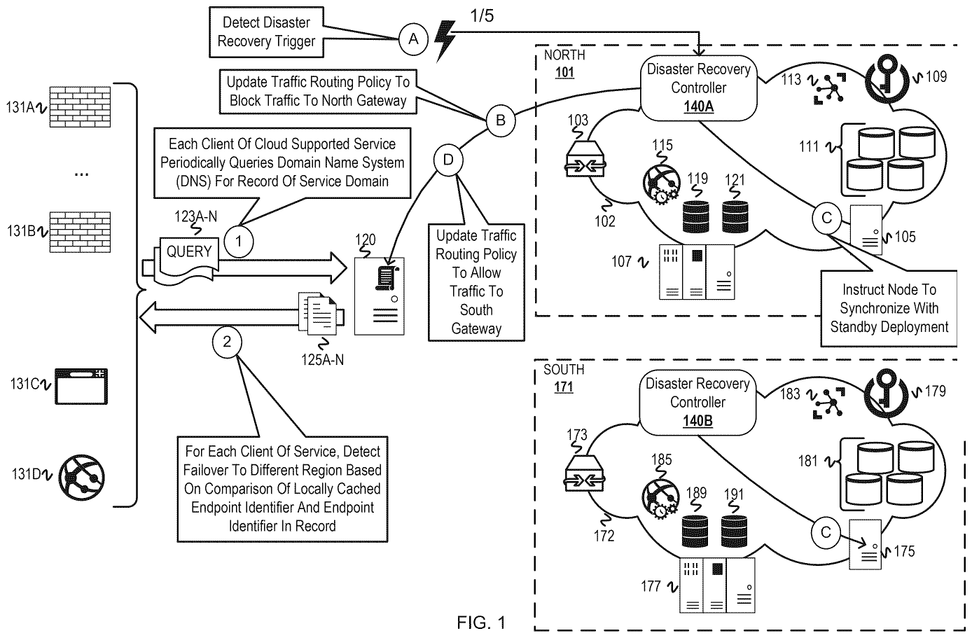

FIG. 1 is a diagram illustrating an efficient DR solution for a cloud-based service from a standby deployment of the cloud-based service to an active deployment of the cloud-based service. For brevity, there will be no distinction between cloud infrastructure and the code running underneath. Upon the completion of the disaster recovery method, the standby region becomes the new active region, and the old active region becomes the new standby region. FIG. 1 depicts two regions 101 and 171, respectively labeled “NORTH” and “SOUTH” to illustrate different geographical regions. Within each of the regions 101, 171 is infrastructure offered by a cloud service provider that supports services. FIG. 1 depicts a cloud infrastructure 102 in the region 101 for an active deployment of an application(s)/service(s) and a cloud infrastructure 172 in the region 171 that supports a standby deployment of the application(s)/service(s). The cloud infrastructures 102, 172 are physically separate infrastructure and data centers.

Cloud infrastructure 102 is depicted with hardware 107 to represent the various hardware (e.g., servers and network devices) of the cloud infrastructure 102, which are physically located in region 101. The cloud infrastructure 102 depicted in FIG. 1 includes a gateway 103 (e.g., an API gateway), a scheduled job 115, storage resources 119, 121, a message bus service 113, a key store or key management service 109, a cluster of storage resources 111 (e.g., database cluster), and a node 105 that manages the cluster of storage resources 111. A disaster recovery controller 140A, being an internal service or containerized function within the infrastructure 102, oversees a failover for DR. The message bus service 113 could be used for exchange of messages among applications and/or services of the cloud infrastructure 102.

The cloud infrastructure 172 in the SOUTH region 171 supports the standby deployment of the application(s)/service(s). To support the standby deployment, the cloud infrastructure 172 will have corresponding resources provisioned as provisioned in the cloud infrastructure 102, such as compute, storage, and cloud services instances. However, the cloud infrastructure 172 will not handle transactions. Accordingly, the cloud infrastructure 172 includes a gateway 173, a scheduled job 185, storage resources 189, 191, a message bus service 183, a key store or key management service 179, a cluster of storage resources 181, and a node 175 that manages the cluster of storage resources 181 and coordinates with the node 105 to synchronize the storage resource clusters 111, 181. While read and write operations will be performed to maintain synchronization of data between the active deployment and the standby deployment, some permissions will be restricted while compute instances still run in a standby state.

For example, the jobs 115, 185 may perform writes to update a data entry in a storage resource. For instance, the job 115 may periodically scan code in the storage resource 119 and update a scan timestamp in the storage resource 119 when the scan is completed. Although the job 185 is configured to perform the same task, the job 185 will not have write permission on the storage resources 189, 191. But the job 185 will still run on schedule without making any updates to a storage resource.

FIG. 1 also depicts a DNS server 120 which handles DNS requests and steers traffic for the cloud infrastructures 102, 172 according to a traffic routing policy. The DNS server 120 is managed by the cloud service provider that offers the cloud resources of the cloud infrastructures 102, 172. The cloud service provider can allow customers to configure traffic routing policies to steer traffic for their applications. For instance, an organization that manages the application deployments in the cloud infrastructures 102, 172 can define a traffic routing policy on the DNS server 120 to steer traffic based on weights assigned to network addresses assigned to load balancers, gateways of the cloud service provider, and/or network devices of a message bus service. FIG. 1 depicts clients of the application 131A-D deployed on the cloud infrastructures 102, 172 as communicating with the DNS server 120.

The clients of the cloud-based application can vary. Clients 131A, 131B represent a fleet of firewalls. Client 131C represents a browser-based client that presents data, such as a dashboard, via a browser. Client 131D represents a web-based service that publishes data to the cloud-based application and/or subscribes to data from the cloud-based application.

FIG. 1 is annotated with a series of letters and numbers A, B, C, D, 1 and 2, each of which represents stages of one or more operations. Although these stages are ordered for this example, the stages illustrate one example to aid in understanding this disclosure and should not be used to limit the claims. Subject matter falling within the scope of the claims can vary from what is illustrated. Stages A, B, C, and D represent stages for operations taken by the disaster recovery controller 140A to failover the active deployment in the region 101 to the standby deployment in the region 171. Stages 1 and 2 represent stages for operations taken by clients 131A-D of the service domain to detect that a failover has occurred. Stages 1 and 2 are performed independently of stages A-D and are performed concurrently.

At stage A, the disaster recovery controller 140A detects a disaster recovery trigger in the NORTH region 101. A disaster recovery trigger can be caused by events such as power outages on data centers, misconfiguration of cloud services, or server failures as a result of natural disasters. In cases where a DR controller is able to directly monitor the health of components of the cloud infrastructure 102 in the region 101, a disaster recovery trigger could be detection of sub-par health of a specific component by the DR controller. In some implementations, an event subscriber framework can be in place where a disaster recovery controller can subscribe to notifications of disaster events from individual components or groups of components of the active deployment which pushes notifications to the DR controller if their own internal health monitoring agents detect a disaster event.

At stage B, the disaster recovery controller 140A instructs the DNS server 120 to block traffic to the “north” gateway 103 of the region 101. A traffic routing policy, which can be a weighted traffic policy, is updated to block traffic to the gateway 103. For instance, a traffic routing policy configured at the DNS server 120 prior to the disaster recover trigger has an assigned weight of 0 for the gateway 173 to block traffic or send 0% of relevant traffic to the gateway 173 and a weight of 1 to allow 100% of relevant application traffic to the gateway 103. In response to the disaster recovery trigger, the DR controller 140A updates the traffic routing policy to also block traffic to the gateway 103 (e.g., assigns a weight of 0 to the DNS record entry corresponding to the gateway 103.

At stage C, the disaster recovery controller 140A instructs the node 105 synchronize the database cluster 111 with the database cluster 181. The node 105 or a different service may be responsible for synchronizing the data of the individual storage resources 119, 121 to the corresponding storage resources 189, 191.For example, batch operations and the individual storage resources 119, 121 can be configured to handle differences in file metadata and types. Upon completion of synchronization, the node 105 notifies the disaster recovery controller 140A that it has completed synchronization of all storage resources.

At stage D, the disaster recovery controller 140A instructs the DNS server 120 to allow traffic to the “south” gateway 173 of the now-active deployment. Similar to the operations in stage B, the DNS server 120 updates a traffic routing policy to steer application traffic to the gateway 173 while continuing to block traffic to the gateway 103.

Stages 1-2 are depicted as sequential stages for batches of requests and responses for simplicity. The operations of stages 1-2 overlap since DNS requests and responses will occur at different times and overlap across requests and responses from different ones of the clients 131A-131D. At stage 1, each of the clients 131A-131D of the cloud-based application communicates a query, collectively depicted as queries 123A-123N to the DNS server 120 for a record of the current service domain to ascertain the regional endpoint identifier. These client queries 123A-N are performed asynchronously with respect to each other. The clients 131A-131D periodically query to ensure that requests are being sent to the current regional endpoint. The query can be accomplished by using a network administration tool (e.g., nslookup).

At stage 2, each of the clients 131A-131D receives a corresponding one of responses 125A-125N from the DNS server 120 and evaluates a corresponding one of the responses 125A-125N to determine whether a regional endpoint has changed. Each of the clients 131A-131D compares an endpoint identifier field in the corresponding one of the DNS responses 125A-125N with a locally cached/stored regional endpoint identifier. If different, a client can parse the endpoint identifiers to extract region identifiers and determine whether a failover has occurred to a different region.

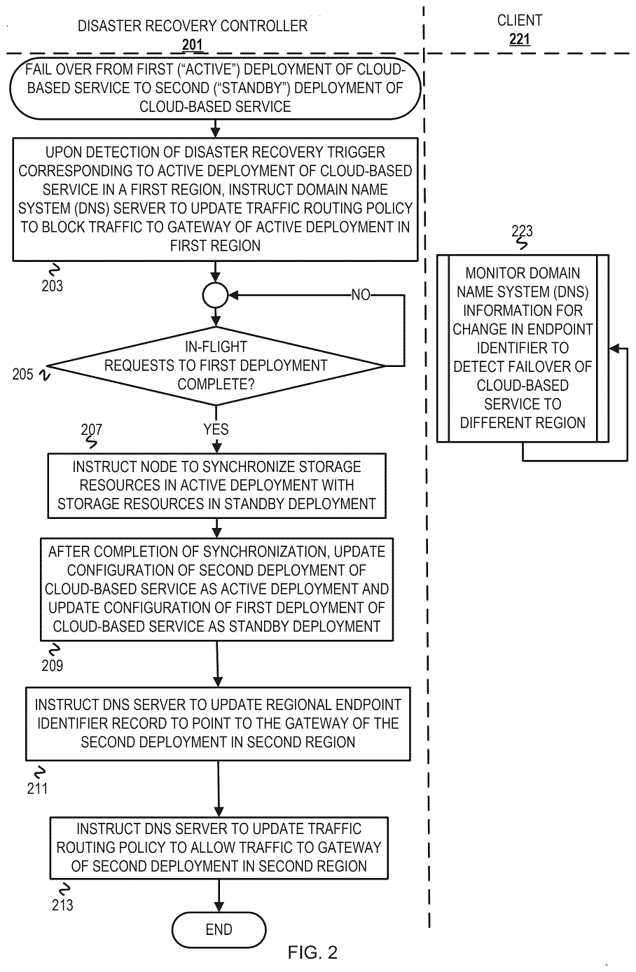

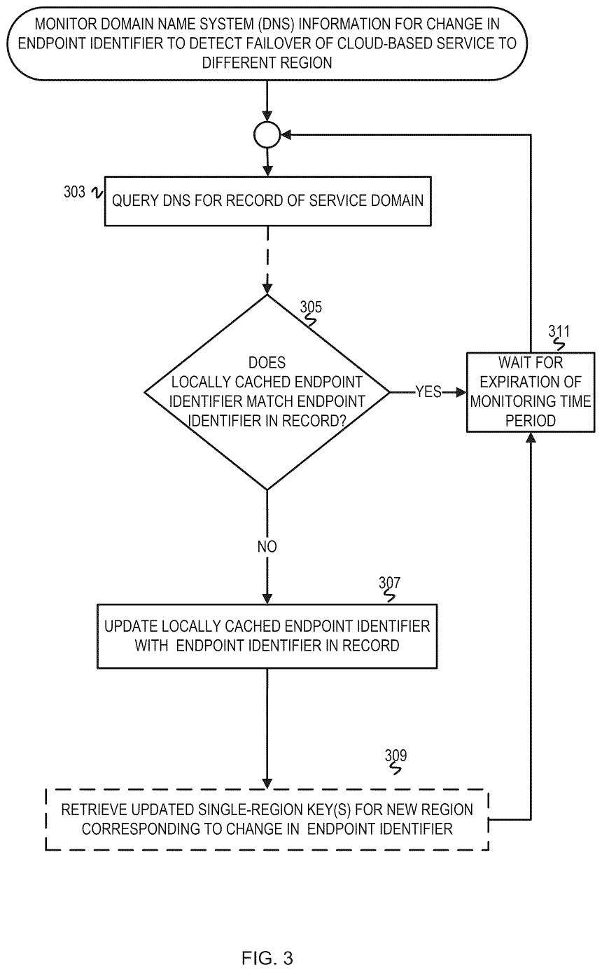

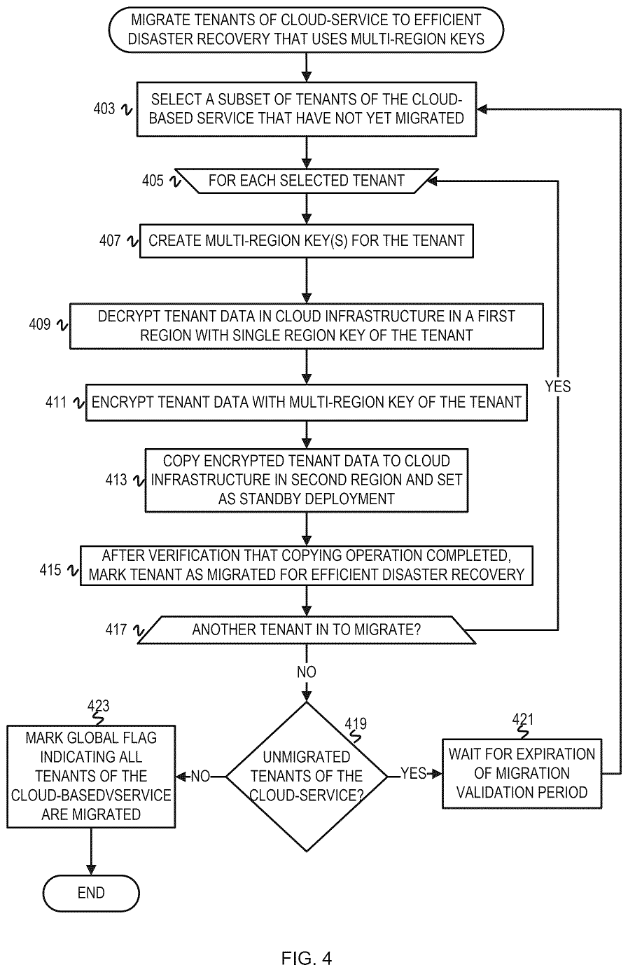

FIG. 2 and FIG. 3 are flowcharts of example operations for regional failover of a cloud-based service and corresponding monitoring for change in regional endpoint of the service by clients of the service. FIG. 4 is a flowchart of operations to migrate tenants of the cloud-based service to an efficient disaster recovery solution that uses multi-region keys. The example operations are described with reference to various named processes or program code. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for failing over from a first deployment of a cloud-based service to a second deployment of a cloud-based service. The first deployment is initially the active deployment. The second deployment is initially the standby deployment. The example operations are described with reference to a disaster recovery controller and a client since the disaster recovery controller and the client (which represents any number of clients of the cloud-based service) operate independently but the aggregate of the operations facilitate efficient cross-region failover.

At block 223, the client 221 monitors DNS information for a change in a regional endpoint of the cloud-based service. When the client 221 begins interacting with the cloud-based service, the client 221 will run program code (e.g., a script) to monitor DNS information for the change. The program code to implement the monitoring may be part of a custom browser used to access the cloud-based service or provided from the cloud-based service. FIG. 3 elaborates on the example operation.

At block 203, the disaster recovery controller, upon detection of a disaster recovery trigger corresponding to the active deployment of the cloud-based service in the first region, instructs a domain name system (DNS) server to update a traffic routing policy to block traffic to the gateway of the active deployment in the first region. In cases where the disaster recovery controller has direct access to update the configuration of the traffic routing policy it can do so directly. A traffic routing policy can be a “weighted” policy where each regional endpoint has a value between zero and N, where N is a positive number. If a regional endpoint identifier has a value of zero, this indicates that 0% of the traffic will be sent to the regional gateway associated with that regional endpoint identifier. A value greater than zero (N) indicates that N % of the traffic will be sent to the regional gateway associated with that regional endpoint identifier. As this operation is occurring in an active/standby framework, the traffic routing policy will initially be configured to steer traffic to a request endpoint in a region corresponding to the active deployment. In contrast, the traffic routing policy will be configured to block traffic or steer traffic away from a request endpoint in a region corresponding to the standby deployment of the cloud-based service.

At block 205, the disaster recovery controller determines if all in-flight request(s) to the active deployment have completed. An in-flight request is a request that has been received by the active deployment but has not finished being processed. An in-flight request may be a request from a client, such as a request that updates an entry in a clustered database. An in-flight request may be coincident with a client request or spawned by a client request. If the disaster recovery controller determines there are in-flight request(s) still being processed by the active deployment, the disaster recovery controller will continue monitoring for completion of in-flight requests as represented by operations continuing at block 205. If the disaster recovery controller determines all in-flight request(s) have completed processing, operations continue at block 207.

At block 207, the disaster recovery controller instructs a node to synchronize storage resources in the active deployment with storage resources in the standby deployment. Database cluster(s) within the active deployment are synchronized with their counterparts in the standby deployment. The node or a different service can also be responsible for synchronizing additional storage resources within the active deployment to their respective counterparts in the standby deployment. In some cases, a database, or database cluster can use their own internal synchronization nodes to coordinate the replication of data to the database cluster in the standby deployment. Upon completion of synchronization, the node will indicate via a notification to the disaster recovery controller that all storage resources have finished synchronizing.

At block 209, the disaster recovery controller, upon receiving a notification that synchronization is complete, updates the configuration of the standby deployment to be the active deployment, and updates the configuration of the active deployment to be the standby deployment. Updating the configuration of either deployment comprises accessing global variables or fields within the configuration and updating their values to reflect their new status as active/standby. The disaster recovery controller in the now-standby deployment can in some cases have direct access to the configuration of the now-active deployment to modify configuration or can instruct the disaster recovery controller in the standby deployment via a notification to update the configuration of the standby deployment.

At block 211, the disaster recovery controller instructs the DNS server to update the regional endpoint identifier record to point to the gateway of the active region. An external client which queries the DNS server for the cloud-based service regional endpoint (i.e., querying to determine the current active deployment endpoint) will receive a response with a payload of the regional endpoint identifier for the gateway of the now-active second region.

At block 213, the disaster recovery controller instructs the DNS server to update the traffic routing policy to steer traffic to the gateway of the standby deployment in the second geographic region. Similar to the operations of block 203, a weighted traffic routing policy can be adjusted to give the second regional endpoint a positive weight to steer traffic to the gateway of the second region. The regional endpoint for the gateway in the first region will keep a weight of zero, continuing to not allow any traffic to be sent to the first region.

FIG. 3 is a flowchart of operations to monitor a DNS server's information for changes in the regional endpoint identifier. This monitoring can be done frequently with little resource consumption to detect failover of cloud-based services to a different region. The operations are described with reference to a client of the cloud-based service.

At block 303, a client, being a member of a collection of clients of the cloud-based service, queries a DNS server for a record of a domain of the cloud-based service. To efficiently query a DNS server, the client uses a Network Administration Tool (NAT), such as nslookup or traceroute. For example, if the service domain for the cloud-based service is: “https://api.data-processing.example.com,” an example nslookup query could be structured: “nslookup api.data-processing.example.com”. The dashed line between blocks 303 and 305 indicates the asynchronous nature of receiving the DNS response.

At block 305, the client determines whether a locally cached regional endpoint identifier matches a regional endpoint identifier in the DNS response. The client parses the DNS response from the DNS server to locate the CNAME record and determines a regional endpoint identifier assigned the CNAME. The CNAME record inside the response can be identified by the label “Name:”. The DNS response using the above query could look like:
“Server: dns.example.local
Address: 8.8.8.8
Answer:
Name: api.data-processing.example.local.
Addresses: api.data-processing.south.example.local.
   192.168.2.0”
      The section “api.data-processing.example.local” of the response is the service domain which was queried. “api.data-processing.south.example.local” is the regional endpoint identifier for the service domain returned by the response. The section “192.168.2.0” is the Internet Protocol (IP)v4 address assigned to the regional endpoint identifier. In this example, the regional endpoint identifier contains the segment “south” which indicates that the south region is the current active region of the cloud-based service. If the client determines that the locally cached regional endpoint identifier matches the regional endpoint identifier in the DNS record, operations continue at block 311. If the client determines that the locally cached endpoint does not match the endpoint identifier in the record, operations continue at block 307. Determination whether the two identifiers match or not can be accomplished through string comparison of the values.

At block 307, the client updates its locally cached endpoint identifier with the endpoint identifier in the DNS record. This operation implicitly indicates to the client that a failover has occurred in the active deployment and there is a new regional endpoint for the cloud-based service.

At block 309, the client retrieves an updated single-region key(s) for the new active region corresponding to the change in the endpoint identifier. The dashed block indicates this is an optional operation in cases where a client, or collection of clients of a tenant of the cloud-based service has not been migrated over to using multi-region keys, a process described in FIG. 4. As a single-region key for the old active region will not work for the new active region, a new key is issued to the client. This key, also referred to as a “Master Key”, is used by the client in conjunction with keys in the key store of the now-active deployment to perform jobs such as encryption or data-signing. If a client has been migrated to use multi-region keys, this operation will not be necessary since the client will already be issued a key that is compatible with both regions.

At block 311, the client waits for expiration of the monitoring time period. This monitoring period can be a regular or irregular interval depending on the implementation. In some cases, this monitoring period can be coordinated with other clients monitoring periods and staggered to prevent unnecessary bulk queries at one time to the DNS server, causing a bottleneck in traffic. When the monitoring period expires, operations will continue at block 303.

FIG. 4 is a flowchart of example operations for migrating tenants of a cloud-based service to efficient disaster recovery that uses multi-region keys. As should be evident, tenant in this description is a cloud tenant, which is an organization that uses/consumes a service/web-application (i.e., the cloud-based service). The example operations are described with reference to a migration agent.

At block 403, a migration agent selects a subset of tenants of the cloud-based service that have not yet been migrated to use the efficient disaster recovery solution. The migration agent can do this by parsing a list of tenants stored by the service provider and selecting a number of tenants that are indicated/flagged as being not migrated. The number of tenants selected can be configured to minimize disruption to client operations, as well as efficiently performing validation of the success of the migration process for each set of selected tenants.

At block 405, the migration agent begins to process each tenant in the selected subset of tenants to be migrated. The migration agent can be configured to generate a notification to the tenant or tenant administrator before initiating the migration.

At block 407, the migration agent creates new multi-region key(s) for the tenant. A multi-region key allows for client devices associated with the tenant to communicate with the cloud infrastructure of the cloud based service across multiple regions. The keystore of an active deployment where the managed keys for each tenant is stored is parsed to determine how many single-region key(s) were associated with the tenant. For each single-region key determined, a new multi-region key is created using the associated single region key as a template. Each new multi-region key will fulfill the same functionality as the corresponding single region key. For example, if a single-region key is associated with signing data in a database, a multi-region key will be created for the same purpose with multi-region capability. In some implementations, a single multi-region key can be used by a tenant for various purposes, or a tenant can provision different keys to different departments of the tenant.

At block 409, the migration agent decrypts the tenant data in the cloud infrastructure in a first region with the tenant's single-region key(s) of the first region. Encrypted tenant data includes data stored on storage resources of the active region as well as configurations of individual components of the active deployment specific to that tenant. The encrypted tenant data is decrypted in preparation to be re-encrypted with the multi-region key(s).

At block 411, the migration agent encrypts the unencrypted tenant data with the multi-region key(s) of the tenant. The encrypted tenant data is then re-stored on storage resources of the active deployment in preparation for being copied to the standby deployment.

At block 413, the migration agent copies the encrypted tenant data to a cloud infrastructure in a second region of the standby deployment. All multi-region keys generated are also replicated into the key store of the standby deployment.

At block 415, upon verification that all tenant data was copied to the standby deployment, the migration agent marks the tenant as migrated for efficient disaster recovery. A flag, or other indicator that the tenant has been migrated is updated in the list of tenants used to select tenants for migration.

At block 417, the migration agent determines if there is another tenant to migrate from the selected subset of tenants. If another tenant is to be migrated, operations continue at block 405. If there are no more tenants in the subset to migrate, then operations continue at block 419.

At block 419, the migration agent determines if there are any unmigrated tenants of the cloud-based service. If there are still unmigrated tenants, operations continue at block 421. If all tenants have been migrated for efficient disaster recovery, operations continue at block 423.

At block 421, the migration agent waits for the expiration of a migration validation period. This validation period can be used by administrators of the cloud-based service to determine if the migration was successful through analysis of event logs, telemetry, etc. After the expiration of the validation period, the operations continue at block 403.

At block 423, the migration agent marks a global flag/indicator that specifies that all tenants of the cloud-based service have migrated. In cases where complete migration is necessary for performing failover to a new region, this indicator can be used to determine if a failover to a new region can happen.

### Variations

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

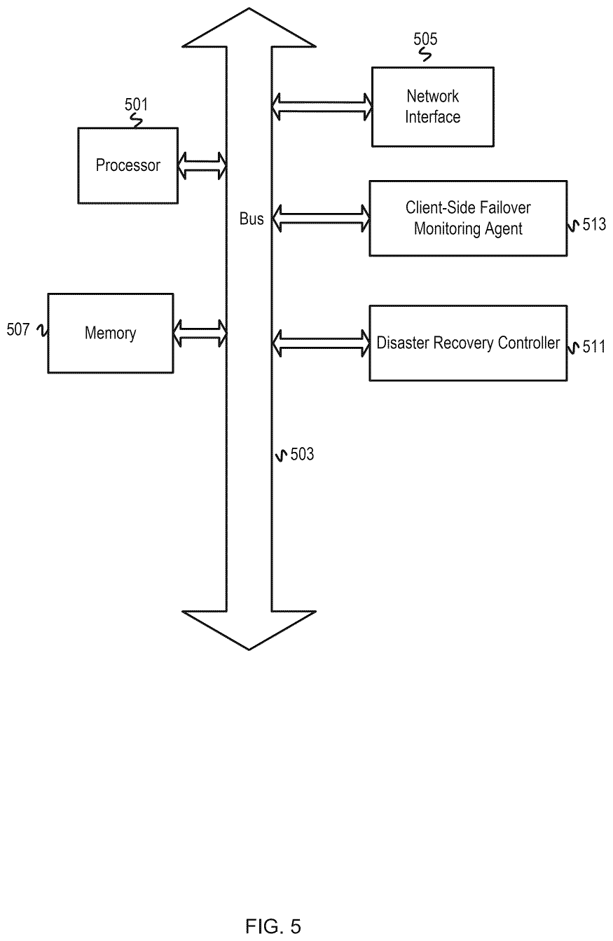

FIG. 5 depicts an example computer system with a disaster recovery controller and a client-side failover monitoring agent. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a disaster recovery controller 511. The computer system also includes DR controller 511 and a client-side failover monitoring agent 513. A server may have both the DR controller 511 and the client-side failover monitoring agent 513 to provide the client-side failover monitoring agent 513 (hereinafter “failover monitoring agent”) to clients of a cloud-based service corresponding to the DR controller 511. A client of a cloud-based service would not host the DR controller 511, but both are depicted in FIG. 5 for efficiency. The DR controller 511 detects a disaster recovery trigger and initiates a failover from an active deployment in a first region to a standby deployment in a second region. The DR controller 511 updates a traffic routing policy on a DNS server associated with the regions of the active and standby deployments of the cloud-based service. The DR controller 511 updates the traffic routing policy to block traffic to the active deployment, and then synchronizes storage resources between the active and standby deployments.

The DR controller 511 updates the traffic routing policy to steer traffic to the standby deployment after synchronization has completed. The failover monitoring agent 513 periodically queries a DNS server to determine whether the regional endpoint of the service domain of the cloud-based service has changed. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501

1. A method comprising:
based on detection of a disaster recovery trigger for a first cloud infrastructure, failing over from the first cloud infrastructure in a first region to a second cloud infrastructure in a second region, wherein failing over comprises,
updating a first traffic routing policy to block traffic to a first gateway of the first cloud infrastructure, wherein the first traffic routing policy is already configured to block traffic to a second gateway of the second cloud infrastructure;
after in-flight requests resolve, synchronizing a first set of one or more storage resources of the first cloud infrastructure and a second set of one or more storage resources of the second cloud infrastructure; and
after synchronizing the first and second sets of storage resources, updating the first traffic routing policy to allow traffic to the second gateway;
concurrently with the failing over, each of a plurality of clients of a first service having a first service domain associated with the first and second gateways,
periodically requesting a domain name system (DNS) record of the first service domain and determining whether the DNS record indicates a different regional endpoint than indicated in configuration data maintained at the client; and
based on a determination that the DNS record indicates a different regional endpoint than indicated in the configuration data, updating the configuration data to indicate a new regional endpoint in the DNS record and communicating with the new regional endpoint for the first service.

2. The method of claim 1, wherein updating the first traffic routing policy comprises accessing the first traffic routing policy at a DNS server associated with the first and second cloud infrastructures and adjusting a first weight in the first traffic routing policy to block traffic to the first gateway, and wherein updating the first traffic routing policy to allow traffic to the second gateway comprises accessing the first traffic routing policy at the DNS server and adjusting a second weight.

3. The method of claim 1, wherein periodically requesting the DNS record of the first service domain comprises periodically invoking a network administration tool to query DNS for the first service domain.

4. The method of claim 1, further comprising waiting for a defined time period to allow in-flight requests to resolve before synchronizing the first and second sets of storage resources, wherein the in-flight requests are requests received before traffic is blocked to the first gateway.

5. The method of claim 1, wherein the new regional endpoint and a previously indicated regional endpoint are different application programming interface (API) gateways.

6. The method of claim 5, wherein determining whether the DNS record indicates a different regional endpoint than indicated in configuration data maintained at the client comprises determining whether the DNS record indicates a same API gateway domain as in the configuration data.

7. The method of claim 1 further comprising, prior to the failing over, migrating tenants to a disaster recovery infrastructure that performs the failing over and uses encryption keys that function in either the first or second region, wherein migrating the tenants comprises migrating the tenants from single region encryption keys to the encryption keys that function in either the first or second region.

8. The method of claim 7, wherein migrating tenants comprises successively migrating different subsets of the tenants with a pause between each successive migrating.

9. The method of claim 1, wherein a second traffic routing policy of the second cloud infrastructure indicates that read requests originating within the second cloud infrastructure be routed to the second set of storage resources in the second cloud infrastructure and the second set of storage resources allow reads but prevent writes not corresponding to synchronizing.

10. The method of claim 1, wherein at least a subset of the plurality of clients comprises firewalls.

11. The method of claim 1 further comprising detecting the disaster recovery trigger.

12. One or more non-transitory machine-readable media having program code stored thereon, the program code comprising:
disaster recovery instructions to,
based on detection of a disaster recovery trigger corresponding to a first cloud infrastructure that supports an active deployment of a first service associated with a first service domain,
update a first traffic routing policy to block traffic to a first gateway of the first cloud infrastructure, wherein the first traffic routing policy is already configured to block traffic to a second gateway of a second cloud infrastructure that supports a standby deployment of the first service;
after in-flight requests for the active deployment of the first service resolve, synchronize a first set of one or more storage resources of the first cloud infrastructure and a second set of one or more storage resources of the second cloud infrastructure; and
after synchronization of the first and second sets of storage resources, update the first traffic routing policy to allow traffic to the second gateway;
client instructions to,
record a regional endpoint identifier of the first gateway when initially interacting with the first service;
periodically request a domain name system (DNS) record of the first service domain and determine whether the DNS record indicates a different regional endpoint identifier than recorded; and
based on a determination that the DNS record indicates a different regional endpoint identifier than recorded, record the different regional endpoint identifier and indicate the different regional endpoint identifier for communicating with the first service.

13. The one or more non-transitory machine-readable media of claim 12, wherein the instructions to update the first traffic routing policy comprise instructions to access the first traffic routing policy at a DNS server associated with the first and second cloud infrastructures and adjust a first weight in the first traffic routing policy to block traffic to the first gateway, and wherein the instructions to update the first traffic routing policy to allow traffic to the second gateway comprise instructions to access the first traffic routing policy at the DNS server and adjust a second weight.

14. The one or more non-transitory machine-readable media of claim 12, wherein the program code further comprises instructions to wait for a defined time period to allow in-flight requests to resolve before synchronization of the first and second sets of storage resources.

15. The one or more non-transitory machine-readable media of claim 12, wherein the program code further comprises migration instructions to prior to fail over, successively migrating in phases different subsets of tenants corresponding to the first service to use encryption keys that function in either the first or second region instead of single region encryption keys.

16. The one or more non-transitory machine-readable media of claim 12, wherein the disaster recovery instructions further comprise instructions to detect the disaster recovery trigger.

17. A system comprising:
a disaster recovery controller comprising a first processor and a first machine-readable medium having stored thereon instructions executable by the first processor to cause the disaster recover controller to,
based on detection of a disaster recovery trigger corresponding to a first cloud infrastructure that supports an active deployment of a first service associated with a first service domain,
update a first traffic routing policy to block traffic to a first gateway of the first cloud infrastructure, wherein the first traffic routing policy is already configured to block traffic to a second gateway of a second cloud infrastructure that supports a standby deployment of the first service;
after in-flight requests for the active deployment of the first service resolve, instruct a node of the first cloud infrastructure to synchronize a first set of one or more storage resources of the first cloud infrastructure and a second set of one or more storage resources of the second cloud infrastructure; and
after synchronization of the first and second sets of storage resources, update the first traffic routing policy to allow traffic to the second gateway; and
a client of the first service comprising a second processor and a second machine-readable medium having stored thereon instructions executable by the second processor to cause the client to,
record a regional endpoint identifier of the first gateway when initially interacting with the first service;
periodically request a domain name system (DNS) record of the first service domain and determine whether the DNS record indicates a different regional endpoint identifier than recorded; and
based on a determination that the DNS record indicates a different regional endpoint identifier than recorded, record the different regional endpoint identifier and indicate the different regional endpoint identifier for communicating with the first service.

18. The system of claim 17, wherein the instructions to update the first traffic routing policy comprise instructions executable by the first processor to cause the disaster recovery controller to access the first traffic routing policy at a DNS server associated with the first and second cloud infrastructures and adjust a first weight in the first traffic routing policy to block traffic to the first gateway, and wherein the instructions to update the first traffic routing policy to allow traffic to the second gateway comprise instructions executable by the first processor to cause the disaster recovery controller to access the first traffic routing policy at the DNS server and adjust a second weight.

19. The system of claim 17, wherein the disaster recovery controller is further programmed to recurrently determine whether in-flight requests have resolved until a determination that the in-flight requests have resolved.

20. The system of claim 17, wherein the first machine-readable medium further comprise instructions executable by the first processor to cause the disaster recovery controller to detect the disaster recovery trigger.
